(19) United States
(12) Patent Application Publication
(10) Pub. No.: US 2024/0158547 A1
(43) Pub. Date: May 16, 2024

(54) COMPOSITION AND POLYMER

(71) Applicant: TOKYO OHKA KOGYO CO., LTD., Kawasaki-shi (JP)

(72) Inventors: Takuya Uehara, Kawasaki-shi (JP); Takehiro Seshimo, Kawasaki-shi (JP)

(21) Appl. No.: 18/493,501

(22) Filed: Oct. 24, 2023

(30) Foreign Application Priority Data
Oct. 27, 2022 (JP) 2022-172176

(51) Int. Cl. C08F 20/14; C08F 12/08; C08F 20/18; C08F 20/56; C08J 5/18

(52) U.S. Cl. CPC C08F 20/14; C08F 12/08; C08F 20/18; C08F 20/56; C08J 5/18; C08F 2810/40; C08J 2325/06; C08J 2333/12; C08J 2333/26

(57) ABSTRACT

A composition for selectively modifying a base material having a surface having two or more regions made of materials that are different from each other and contains a polymer and a solvent, in which the polymer has at least one structure represented by Formula (1-1) at a terminal of a main chain thereof. In the formula, X represents NR₁, O, S, or Te; R₁ represents a hydrogen atom or a hydrocarbon group having 1 to 20 carbon atoms; A₁ represents a monovalent substituent having substrate adsorbability at a terminal; and * represents a bonding site that is bonded to the main chain of the polymer

*—X-A₁ (1-1).

### BACKGROUND OF THE INVENTION

### Field of the Invention

The present invention relates to a composition which is used for selectively modifying a base material having a surface having two or more regions made of materials that are different from each other, and a polymer useful as a base material component of the composition.

Priority is claimed on Japanese Patent Application No. 2022-172176, filed on Oct. 27, 2022, the content of which is incorporated herein by reference.

### Description of Related Art

In response to the further miniaturization of semiconductor devices, a technique for forming a fine pattern of less than 30 nm has been required. However, this has become technically difficult for the conventional method using lithography because of optical factors and the like.

Therefore, the formation of a fine pattern using a so-called bottom-up technique is being studied. As this bottom-up technique, a method of utilizing the self-organization of polymers is being studied. For example, Patent Document 1 proposed an undercoat agent containing a polymer compound (A1), in which a first polymer block and a second polymer block are bonded through a linking group including a substrate adhesiveness group, as an undercoat agent used for phase separation of a layer containing a block copolymer.

In addition, a method for selectively modifying a base material having a fine region on a surface layer is being studied. For this selective modification method, a material capable of easily and highly selectively modifying the surface region is required, and various materials are being studied (refer to Non-Patent Document 1).

### CITATION LIST

### Patent Document

[Patent Document 1] Japanese Unexamined Patent Application, First Publication No. 2018-159061

### Non-Patent Document

[Non-Patent Document 1] J. Phys. Chem. C 2014, 118, 10957-10962

### SUMMARY OF THE INVENTION

For the method for selectively modifying a base material having a fine region on a surface layer, a polymer brush having an adsorptive terminal group is under development. However, substrate selectivity, adhesiveness, and a polymer brush formation density may not always be sufficient because of a high steric hindrance peculiar to a polymer.

The present invention has been made in view of the above-mentioned circumstances, and an object thereof is to provide a composition having favorable substrate selectivity and a favorable polymer brush formation density, and a polymer useful as a base material component of the composition.

In order to achieve the above-mentioned object, the present invention adopts the following constitution.

In other words, a first aspect of the present invention is a composition which is used for selectively modifying a base material having a surface having two or more regions made of materials that are different from each other, the composition containing: a polymer; and a solvent, in which the polymer has at least one structure represented by Formula (1-1) at a terminal of a main chain.

[Chem. 1]

*—X-A₁ (1-1)

[In the formula, X represents NR₁, O, S, or Te; R₁ represents a hydrogen atom or a hydrocarbon group having 1 to 20 carbon atoms; A₁ represents a monovalent substituent having substrate adsorbability at a terminal; and * represents a bonding site that is bonded to the main chain of the polymer.]

A second aspect of the present invention is a polymer having at least one structure represented by Formula (2-1) at a terminal of a main chain.

[Chem. 2]

*—X-B₁ (2-1)

[In the formula, X represents NR₁, O, S, or Te; R₁ represents a hydrogen atom or a hydrocarbon group having 1 to 20 carbon atoms; B₁ represents a monovalent substituent having, at a terminal, a cyano group, a thiol group, a vinyl group, an ethynyl group, a phosphoric acid group, a phosphoric acid ester group, a phosphonic acid group, a phosphonic acid ester group, a sulfonic acid group, a sulfonic acid ester group, an epoxy group, a pyridyl group, a pyrimidyl group, an imidazole group, a diazonio group, or a halogen; and * represents a bonding site that is bonded to the main chain of the polymer.]

According to the present invention, a composition having favorable substrate selectivity and a favorable polymer brush formation density, and a polymer useful as a base material component of the composition can be provided.

### DETAILED DESCRIPTION OF THE INVENTION

In the present specification and the scope of the present claims, the term “aliphatic” is a relative concept used with respect to the term “aromatic” and defines a group, a compound, or the like which has no aromaticity.

The term “alkyl group” includes a monovalent saturated hydrocarbon group that is linear, branched, or cyclic unless otherwise specified. The same applies to the alkyl group of an alkoxy group.

The term “alkylene group” includes a divalent saturated hydrocarbon group that is linear, branched, or cyclic unless otherwise specified.

Examples of the “halogen atom” include a fluorine atom, a chlorine atom, a bromine atom, and an iodine atom.

The term “constitutional unit” means a monomer unit (a monomeric unit) that constitutes a polymer compound (a resin, a polymer, or a copolymer).

When the phrase “may have a substituent” is described, this includes both of a case in which a hydrogen atom (—H) is substituted with a monovalent group and a case in which a methylene group (—CH₂—) is substituted with a divalent group.

The phrase “constitutional unit derived from” means a constitutional unit that is constituted by the cleavage of a multiple bond between carbon atoms, for example, an ethylenic double bond.

In the “acrylic acid ester”, the hydrogen atom bonded to the carbon atom at the α-position may be substituted with a substituent. The substituent (R^{αx}) with which the hydrogen atom bonded to the carbon atom at the α-position is substituted is an atom other than a hydrogen atom or a group. Furthermore, an itaconic acid diester in which the substituent (R^{αx}) is substituted with a substituent having an ester bond, and an α-hydroxyacryl ester in which the substituent (R^{αx}) is substituted with a hydroxyalkyl group or a group in which a hydroxyl group thereof is modified are also included. A carbon atom at the α-position of the acrylic acid ester is a carbon atom to which the carbonyl group of acrylic acid is bonded, unless otherwise specified.

Hereinafter, the acrylic acid ester in which the hydrogen atom bonded to the carbon atom at the α-position is substituted with a substituent may also be referred to as an α-substituted acrylic acid ester.

The term “derivative” is a concept including a compound in which the hydrogen atom at the α-position of a target compound has been substituted with another substituent such as an alkyl group and a halogenated alkyl group, and including derivatives thereof. Examples of the derivatives thereof include a derivative in which the hydrogen atom of the hydroxyl group of a target compound, in which the hydrogen atom at the α-position may be substituted with a substituent, is substituted with an organic group; and a derivative in which a substituent other than a hydroxyl group is bonded to a target compound in which the hydrogen atom at the α-position may be substituted with a substituent. The term “α-position” refers to the first carbon atom adjacent to a functional group unless otherwise specified.

Examples of substituents with which the hydrogen atom at the α-position of hydroxystyrene is substituted include are the same as those for R^{αx}.

In the present specification and the scope of the present claims, depending on structures represented by chemical formulas, asymmetrical carbon may be present, and thus enantiomers or diastereomers may be present. In this case, these isomers are represented by one chemical formula. These isomers may be used alone or may be used as a mixture.

(Composition)

A composition according to the present embodiment (hereinafter, also simply referred to as “composition (I)”) is used for the selective modification of a base material (hereinafter, also simply referred to as “treated surface”) having a surface having two or more regions made of materials that are different from each other. It is preferable that, in the treated surface, at least one region of the two or more regions have a metal surface, and that the composition according to the present embodiment be used for selectively modifying the metal region.

In the present embodiment, when the treated surface has two regions, the treated surface has a first region, and has a second region that is made of a material different from that of the first region and is adjacent to the first region. In such a case, the phrase “proximity regions” are the first region and the second region.

Each of the first region and the second region may or may not be divided into a plurality of regions.

In the present embodiment, when the treated surface has three or more regions, the treated surface has a first region, has a second region that is made of a material different from that of the first region and is adjacent to the first region, and has a third region that is made of a material different from that of the second region and is adjacent to the second region. In such a case, the phrase “proximity regions” may be the first region and the second region (that is, the adjacent regions), or may be the first region and the third region (that is, a region after the adjacent region).

Furthermore, when the first region and the third region are made of the same material, the phrase “proximity regions” are the first region and the second region, or the second region and the third region (that is, adjacent regions).

Each of the first region, the second region, and the third region may or may not be divided into a plurality of regions.

In the present embodiment, the same idea can be applied to the case in which the treated surface has the fourth or more regions.

The upper limit value of the number of regions made of different materials is not particularly limited as long as the effects of the present invention are not impaired, and for example, the upper limit value is 7 or less or 6 or less, and is typically 5 or less.

In the present embodiment, examples of the treated surfaces include a base material in which a surface layer has a region (I) containing a metal (A).

The metal (A) is not particularly limited as long as it is a metal element. Silicon is non-metal and does not correspond to the metal. Examples of the metal (A) include copper, iron, zinc, cobalt, aluminum, tin, tungsten, zirconium, titanium, tantalum, germanium, molybdenum, ruthenium, gold, silver, platinum, palladium, and nickel. Among these, copper, cobalt, tungsten, and tantalum are preferable.

Examples of incorporation forms of the metal (A) in the region (I) include elemental metals, alloys, conductive nitrides, metal oxides, and silicides.

Examples of the elemental metals include elemental metals such as copper, iron, cobalt, tungsten, and tantalum.

Examples of the alloys include a nickel-copper alloy, a cobalt-nickel alloy, and a gold-silver alloy.

Examples of the conductive nitrides include tantalum nitride, titanium nitride, iron nitride, and aluminum nitride.

Examples of the metal oxides include tantalum oxide, aluminum oxide, iron oxide, and copper oxide.

Examples of the silicides include an iron silicide and a molybdenum silicide. Among these, an elemental metal, an alloy, a conductive nitride, and a silicide are preferable; an elemental metal and a conductive nitride are more preferable; and elemental copper, elemental cobalt, elemental tungsten, elemental tantalum, and tantalum nitride are further preferable.

The surface layer of the base material may have a region (II) substantially formed of only a non-metal (B), in addition to the region (I).

Examples of elemental non-metals include elements such as silicon and carbon.

Examples of non-metal oxides include silicon oxide.

Examples of non-metal nitrides include SiNx and Si3N4.

Examples of non-metal oxynitrides include SiON. Among these, non-metal oxides are preferable, and silicon oxide is more preferable.

The presence shape of the region (I) and/or the region (II) in the surface layer of the base material is not particularly limited, and examples thereof include a planar shape, a dot shape, and a striped shape when seen in a plan view. The sizes of the region (I) and the region (II) are not particularly limited, and the regions can have a desired size as appropriate.

The shape of the base material is not particularly limited, and the shape can be appropriately set to a desired shape such as a plate-like (substrate) shape and a spherical shape.

A composition (I) according to the present embodiment contains a polymer (A) and a solvent (B). The composition (I) may contain other components in addition to the polymer (A) and the solvent (B).

(Polymer (A))

The polymer (A) has at least one structure represented by Formula (1-1) (hereinafter also simply referred to as “structure (1-1)”) at the terminal of the main chain. The term “main chain” refers to the longest atomic chain of the polymer. The term “side chain” refers to a chain other than the main chain among the atomic chains of the polymer. From the viewpoint of further increasing the density of the polymer (A) to be surface-modified, the polymer (A) preferably has the structure (1-1) at one terminal of the main chain.

[Chem. 3]

*—X-A₁ (1-1)

[In the formula, X represents NR₁, O, S, or Te; R₁ represents a hydrogen atom or a hydrocarbon group having 1 to 20 carbon atoms; A₁ represents a monovalent substituent having substrate adsorbability at a terminal; and * represents a bonding site that is bonded to the main chain of the polymer.]

Examples of the hydrocarbon groups represented by R₁ include a linear or branched alkyl group and a cyclic hydrocarbon group.

The linear alkyl group represented by R₁ preferably has 1 to 20 carbon atoms, more preferably has 1 to 10 carbon atoms, and further preferably has 1 to 5 carbon atoms. Specific examples thereof include a methyl group, an ethyl group, an n-propyl group, an n-butyl group, and an n-pentyl group.

The branched alkyl group represented by R₁ preferably has 3 to 20 carbon atoms, more preferably has 3 to 10 carbon atoms, and further preferably has 3 to 5 carbon atoms. Specific examples thereof include an isopropyl group, an isobutyl group, a tert-butyl group, an isopentyl group, a neopentyl group, a 1,1-diethylpropyl group, and a 2,2-dimethylbutyl group.

When R₁ represents a cyclic hydrocarbon group, the hydrocarbon group may be an alicyclic hydrocarbon group or an aromatic hydrocarbon group, and may be a polycyclic group or a monocyclic group.

The alicyclic hydrocarbon group which is a monocyclic group is preferably a group in which one hydrogen atom has been removed from a monocycloalkane. The monocycloalkane preferably has 3 to 6 carbon atoms, and specific examples thereof include cyclopentane and cyclohexane.

The alicyclic hydrocarbon group which is a polycyclic group is preferably a group in which one hydrogen atom has been removed from a polycycloalkane. The polycycloalkane preferably has 7 to 12 carbon atoms, and specific examples thereof include adamantane, norbornane, isobornane, tricyclodecane, and tetracyclododecane.

When the cyclic hydrocarbon group as R₁ is an aromatic hydrocarbon group, the aromatic hydrocarbon group is a hydrocarbon group having at least one aromatic ring.

This aromatic ring is not particularly limited as long as it is a cyclic conjugated system having (4n+2) π electrons, and may be monocyclic or polycyclic. The aromatic ring preferably has 5 to 30 carbon atoms, more preferably has 5 to 20 carbon atoms, further preferably has 6 to 15 carbon atoms, and particularly preferably has 6 to 12 carbon atoms.

Specific examples of the aromatic rings include aromatic hydrocarbon rings such as benzene, naphthalene, anthracene, and phenanthrene; and an aromatic heterocyclic ring in which a part of carbon atoms constituting the above-mentioned aromatic hydrocarbon ring has been substituted with a hetero atom. Examples of the hetero atoms in the aromatic heterocyclic rings include an oxygen atom, a sulfur atom, and a nitrogen atom. Specific examples of the aromatic heterocyclic rings include a pyridine ring and a thiophene ring.

Specific examples of the aromatic hydrocarbon group as R₁ include a group (an aryl group or a heteroaryl group) in which one hydrogen atom has been removed from the aromatic hydrocarbon ring or the aromatic heterocyclic ring; a group in which one hydrogen atom has been removed from an aromatic compound (such as biphenyl and fluorene) having two or more aromatic rings; and a group (for example, an arylalkyl group such as a benzyl group, a phenethyl group, a 1-naphthylmethyl group, a 2-naphthylmethyl group, a 1-naphthylethyl group, and a 2-naphthylethyl group) in which one hydrogen atom of the aromatic hydrocarbon ring or the aromatic heterocyclic ring has been substituted with an alkylene group. The alkylene group bonded to the aromatic hydrocarbon ring or the aromatic heterocyclic ring preferably has 1 to 4 carbon atoms, more preferably has 1 or 2 carbon atoms, and particularly preferably has 1 carbon atom.

In Formula (1-1) above, X is preferably S from the viewpoint of easiness in synthesizing the polymer (A).

In Formula (1-1) above, A₁ represents a monovalent substituent (hereinafter, also simply referred to as a “substituent (A₁)”) having substrate adsorbability at the terminal. The substituent (A₁) is typically a group containing a functional group (hereinafter, “functional group (A)”) that is bonded to the metal (A). For example, this bond is a chemical bond, and examples thereof include a covalent bond, an ionic bond, and a coordination bond. Among these, a coordination bond is preferable from the viewpoint of larger bonding force between the metal and the functional group.

Examples of the functional group (A) include a cyano group, a thiol group, a vinyl group, an ethynyl group, a phosphoric acid group, a phosphoric acid ester group, a phosphonic acid group, a phosphonic acid ester group, a sulfonic acid group, a sulfonic acid ester group, an epoxy group, a pyridyl group, a pyrimidyl group, an imidazole group, a diazonio group, and a halogen. Among these, as the functional group (A), a phosphoric acid group, a phosphoric acid ester group, a pyridyl group, or an imidazole group is preferable.

In Formula (1-1) above, A₁ is preferably a group represented by Formula (A-11) below.

[Chem. 4]

*—R_{A}-A₂ (A-11)

[In the formula, R_{A} represents a divalent linking group; A₂ represents a monovalent substituent having substrate adsorbability at a terminal; and * represents a bonding site that is bonded to X in Formula (1-1) above.]

In Formula (A-11) above, a divalent linking group as R_{A} is not particularly limited, and suitable examples thereof include a divalent hydrocarbon group that may have a substituent, and a divalent linking group having a hetero atom.

R_{A} is preferably an ester bond [—C(═O)—O—], an ether bond (—O—), a linear or branched alkylene group, or a combination of these, and is more preferably a linear or branched alkylene group.

Among them, from the viewpoint of easiness in synthesizing the polymer (A), R_{A} is preferably a linear alkylene group having 1 to 10 carbon atoms, more preferably an alkylene group having 1 to 5 carbon atoms, further preferably an alkylene group having 1 to 3 carbon atoms, and particularly preferably an ethylene group.

A₂ represents a monovalent substituent having substrate adsorbability at the terminal and is the same as the above-mentioned functional group (A).

In the present embodiment, the above-mentioned polymer preferably has at least one structure represented by Formula (1-2) (hereinafter, also simply referred to as “structure (1-2)”) at the terminal of the main chain.

[Chem. 5]

*—S-A₁ (1-2)

[In the formula, A₁ represents a monovalent substituent having substrate adsorbability at the terminal; and * represents a bonding site that is bonded to the main chain of the above-mentioned polymer.]

In Formula (1-2) above, the monovalent substituent having substrate adsorbability at the terminal as A₁ is the same as the monovalent substituent having substrate adsorbability at the terminal as A₁ in Formula (1-1) above.

In Formula (1-2) above, A₁ is preferably a group represented by Formula (A-12) below.

[Chem. 6]

*—R_{A}-A₂ (A-12)

[In the formula, R_{A} represents a divalent linking group; A₂ represents a monovalent substituent having substrate adsorbability at the terminal; and * represents a bonding site that is bonded to S.]

In Formula (A-12) above, the divalent linking group as R_{A} is the same as the divalent linking group as R_{A} in Formula (A-11) above.

In Formula (A-12) above, the monovalent substituent having substrate adsorbability at the terminal as A₂ is the same as the above-mentioned functional group (A).

The polymer (A) is not particularly limited as long as it is a polymer having at least one structure (1-1) mentioned above at the terminal of the main chain, and examples thereof include polymers having a structural unit derived from substituted or unsubstituted styrene, a structural unit derived from a (meth)acrylic acid or a (meth)acrylic acid ester, or a structural unit derived from substituted or unsubstituted ethylene, or the like. In addition, the polymer (A) may have a structural unit including a crosslinkable group. The polymer (A) may have one or two or more of each of a structural unit derived from substituted or unsubstituted styrene, a structural unit derived from a (meth)acrylic acid or a (meth)acrylic acid ester, a structural unit derived from substituted or unsubstituted ethylene, and/or a structural unit having a crosslinkable group. The term “crosslinkable group” refers to a group that forms a crosslinking structure by a reaction under a heating condition, an active energy ray irradiation condition, an acidic condition, or the like.

Examples of monomers that provide the above-mentioned structural unit derived from substituted or unsubstituted styrene include styrene, α-methylstyrene, o-, m-, p-methylstyrene, p-t-butylstyrene, 2,4,6-trimethylstyrene, p-methoxystyrene, p-t-butoxystyrene, o-, m-, p-vinylstyrene, o-, m-, p-hydroxystyrene, m-, p-chloromethylstyrene, p-chlorostyrene, p-bromostyrene, p-iodostyrene, p-nitrostyrene, and p-cyanostyrene.

Examples of monomers that provide the above-mentioned structural unit derived from a (meth)acrylic acid ester include (meth)acrylic acid alkyl esters such as methyl (meth)acrylate, ethyl (meth)acrylate, t-butyl (meth)acrylate, and 2-ethylhexyl (meth)acrylate; (meth)acrylic acid cycloalkyl esters such as cyclopentyl (meth)acrylate, cyclohexyl (meth)acrylate, 1-methylcyclopentyl (meth)acrylate, 2-ethyladamantyl (meth)acrylate, and 2-(adamantan-1-yl)propyl (meth)acrylate; (meth)acrylic acid aryl esters such as phenyl (meth)acrylate and naphthyl (meth)acrylate; and substituted alkyl esters of (meth)acrylic acid such as 2-hydroxyethyl (meth)acrylate, 3-hydroxyadamantyl (meth)acrylate, 3-glycidylpropyl (meth)acrylate, and 3-trimethylsilylpropyl (meth)acrylate.

Examples of monomers that provide the above-mentioned structural unit derived from substituted or unsubstituted ethylene include ethylene; alkenes such as propene, butene, and pentene; vinylcycloalkanes such as vinylcyclopentane and vinylcyclohexane; cycloalkenes such as cyclopentene and cyclohexene; 4-hydroxy-1-butene; glycidyl vinyl ethers; and trimethylsilyl vinyl ethers.

The lower limit of the content ratio of the monomer that provides the above-mentioned structural unit derived from substituted or unsubstituted styrene, the above-mentioned structural unit derived from a (meth)acrylic acid ester, or the above-mentioned structural unit derived from substituted or unsubstituted ethylene is preferably 20 mol % or more, more preferably 40 mol % or more, and further preferably 60 mol % or more with respect to all of repeating units constituting the polymer (A). The upper limit of the above-mentioned content ratio may be 100 mol % or less, is preferably 90 mol % or less in some cases, and is more preferably 85 mol % or less in some cases.

Examples of the above-mentioned crosslinkable group include polymerizable carbon-carbon double bond-containing groups such as a vinyl group, a vinyloxy group, an allyl group, a (meth)acryloyl group, and a styryl group; polymerizable carbon-carbon triple bond-containing groups such as an ethynyl group, a propargyl group, a propargyloxy group, and a propargylamino group; cyclic ether groups such as an oxiranyl group, an oxiranyloxy group, an oxetanyl group, and an oxetanyloxy group; aryl groups with a fused cyclobutane ring, such as a phenyl group with a fused cyclobutane ring, and a naphthyl group with a fused cyclobutane ring; aryl groups, to which a phenolic hydroxyl group protected by an acid group or a thermally dissociable group is bonded, such as an acetoxyphenyl group and a t-butoxyphenyl group; aryl groups, to which a methylol group (—CH₂OH) protected by an acid group or a thermally dissociable group is bonded, such as an acetoxymethylphenyl group and a methoxymethylphenyl group; and aryl groups, to which a substituted or unsubstituted sulfanylmethyl group (—CH₂SH) is bonded, such as a sulfanylmethylphenyl group and a methylsulfanylmethylphenyl group.

The aryl groups with a fused cyclobutane ring form a covalent bond between each other under a heating condition.

The term “acid group” is a group in which OH has been removed from an acid, and refers to a protective group that substitutes a hydrogen atom of a phenolic hydroxyl group or a methylol group. The term “thermally dissociable group” is a group that substitutes a hydrogen atom of a phenolic hydroxyl group, a methylol group, or a sulfanylmethyl group, and refers to a group that is dissociated by heating.

Examples of the acid groups in the aryl group to which a protected phenolic hydroxyl group, a methylol group, or a sulfanylmethyl group is bonded include a formyl group, an acetyl group, a propionyl group, a butyryl group, and a benzoyl group.

Examples of the thermally dis sociable groups in the aryl group to which a protected phenolic hydroxyl group is bonded include tertiary alkyl groups such as a t-butyl group and a t-amyl group. Examples of the thermally dissociable groups in the aryl group to which a protected methylol group or a sulfanylmethyl group is bonded include alkyl groups such as a methyl group, an ethyl group, and a propyl group.

Among the above examples, the crosslinkable group is preferably a polymerizable carbon-carbon double bond-containing group or an aryl group with a fused cyclobutane ring, and is more preferably an allyl group or a phenyl group with a fused cyclobutane ring.

Examples of the above-mentioned structural unit having a crosslinkable group include a structural unit derived from a vinyl compound having a crosslinkable group, and a structural unit derived from a (meth)acrylic compound having a crosslinkable group.

The above-mentioned structural unit having a crosslinkable group is preferably a structural unit derived from a (meth)acrylic compound having a polymerizable carbon-carbon double bond-containing group, or a structural unit derived from a vinyl compound having an aryl group with a fused cyclobutane ring, and is more preferably a structural unit derived from allylstyrene, or a structural unit derived from 4-vinylbenzocyclobutene.

When the polymer (A) has the above-mentioned structural unit having a crosslinkable group, the lower limit of the content ratio of the above-mentioned structural unit having a crosslinkable group is preferably 0.1 mol % or more, more preferably 1 mol % or more, further preferably 3 mol % or more, and particularly preferably 4 mol % or more with respect to all of the repeating units constituting the polymer (A). The upper limit of the above-mentioned content ratio is preferably 20 mol % or less, more preferably 15 mol % or less, further preferably 10 mol % or less, and particularly preferably 8 mol % or less.

The polymer (A) is preferably a polymer having the structural unit derived from substituted or unsubstituted styrene, the structural unit derived from a (meth)acrylic acid or a (meth)acrylic acid ester, and/or the structural unit having a crosslinkable group; is more preferably a polymer having the structural unit derived from substituted or unsubstituted styrene, a polymer having the structural unit derived from a (meth)acrylic acid ester, or a polymer having the structural unit derived from substituted or unsubstituted styrene and the structural unit having a crosslinkable group; is further preferably a polymer having the structural unit derived from substituted or unsubstituted styrene, a polymer having the structural unit derived from a (meth)acrylic acid ester, or a polymer that has the structural unit derived from substituted or unsubstituted styrene and has a repeating unit derived from a vinyl compound having an aryl group with a fused cyclobutane ring; and is even further preferably polystyrene, polymethyl methacrylate, polymethyl acrylate, polyacrylamide derivatives, poly(methylcyclopentyl methacrylate), or a styrene-methyl methacrylate copolymer.

In the present embodiment, the polymer (A) is preferably a polymer having a constitutional unit represented by General Formula (a1-1) below.

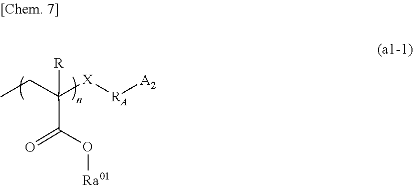

[In the formula, R represents a hydrogen atom, an alkyl group having 1 to 5 carbon atoms, or a halogenated alkyl group having 1 to 5 carbon atoms; Ra⁰¹ represents a linear or branched alkyl group; X represents NR₁, O, S, or Te; R₁ represents a hydrogen atom or a hydrocarbon group having 1 to 20 carbon atoms; R_{A} represents a divalent linking group; A₂ represents a monovalent substituent having substrate adsorbability at the terminal; and n represents an integer of 10 to 500.]

In Formula (a1-1) above, the alkyl group having 1 to 5 carbon atoms as R is preferably a linear or branched alkyl group having 1 to 5 carbon atoms, and specific examples thereof include a methyl group, an ethyl group, a propyl group, an isopropyl group, an n-butyl group, an isobutyl group, a tert-butyl group, a pentyl group, an isopentyl group, and a neopentyl group. The halogenated alkyl group having 1 to 5 carbon atoms is a group in which a part or all of hydrogen atoms in the above-mentioned alkyl group having 1 to 5 carbon atoms have been substituted with a halogen atom. The halogen atom is particularly preferably a fluorine atom.

R is preferably a hydrogen atom, an alkyl group having 1 to 5 carbon atoms, or a fluorinated alkyl group having 1 to 5 carbon atoms, and is most preferably a hydrogen atom or a methyl group from the viewpoint of industrial availability.

In Formula (a1-1) above, the linear alkyl group represented by Ra⁰¹ preferably has 1 to 20 carbon atoms, more preferably has 1 to 10 carbon atoms, and further preferably has 1 to 5 carbon atoms. Specific examples thereof include a methyl group, an ethyl group, an n-propyl group, an n-butyl group, and an n-pentyl group.

The branched alkyl group represented by Ra⁰¹ preferably has 3 to 20 carbon atoms, more preferably has 3 to 10 carbon atoms, and further preferably has 3 to 5 carbon atoms. Specific examples thereof include an isopropyl group, an isobutyl group, a tert-butyl group, an isopentyl group, a neopentyl group, a 1,1-diethylpropyl group, and a 2,2-dimethylbutyl group.

Among them, Ra⁰¹ is preferably a linear alkyl group having 1 to 5 carbon atoms, is more preferably a linear alkyl group having 1 to 3 carbon atoms, and is further preferably a methyl group.

X in Formula (a1-1) above is the same as X in Formula (1-1) above.

R_{A} and A₂ in Formula (a1-1) above are the same as R_{A} and A₂ in Formula (A-11) above.

In Formula (a1-1) above, n is an integer of 10 to 500, is preferably an integer of 30 to 300, and is more preferably an integer of 50 to 200.

Specific examples of the polymers (A) are described below.

In the formulas shown below, R^{α} represents a hydrogen atom, a methyl group, or a trifluoromethyl group.

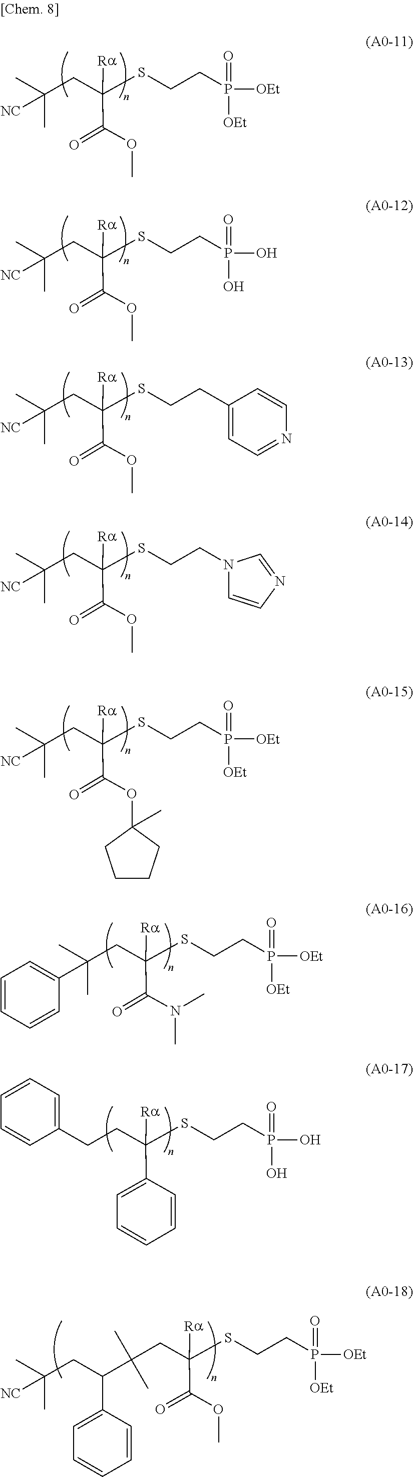

The lower limit of the number-average molecular weight (Mn) of the polymer (A) is preferably 500 or more, more preferably 2,000 or more, further preferably 4,000 or more, and particularly preferably 5,000 or more. The upper limit of Mn mentioned above is preferably 50,000 or less, more preferably 30,000 or less, further preferably 15,000 or less, and particularly preferably 10,000 or less.

The upper limit of the ratio (Mw/Mn, degree of dispersion) of the weight-average molecular weight (Mw) of the polymer (A) to Mn is preferably 5 or less, more preferably 2 or less, further preferably 1.5 or less, and particularly preferably 1.3 or less. The lower limit of the above-mentioned ratio is usually 1 or more, and is preferably 1.05 or more.

The lower limit of the content of the polymer (A) is preferably 80% by mass, is more preferably 90% by mass, and is further preferably 95% by mass with respect to the total solid content in the composition (I). The upper limit of the above-mentioned content is 100% by mass, for example. The term “total solid content” refers to the total sum of components other than the [B] solvent.

([B] Solvent)

The [B] solvent is not particularly limited as long as it is a solvent capable of dissolving or dispersing at least the polymer (A) and other components.

Examples of the [B] solvent include alcohol solvents, ether solvents, ketone solvents, amide solvents, ester solvents, and hydrocarbon solvents.

Examples of the alcohol solvents include aliphatic monoalcohol solvents having 1 to 18 carbon atoms such as 4-methyl-2-pentanol and n-hexanol; alicyclic monoalcohol solvents having 3 to 18 carbon atoms such as cyclohexanol; polyhydric alcohol solvents having 2 to 18 carbon atoms such as 1,2-propylene glycol; and polyhydric alcohol partial ether solvents having 3 to 19 carbon atoms such as propylene glycol monomethyl ether.

Examples of the ether solvents include dialkyl ether solvents such as diethyl ether, dipropyl ether, dibutyl ether, dipentyl ether, diisoamyl ether, dihexyl ether, and diheptyl ether; cyclic ether solvents such as tetrahydrofuran and tetrahydropyran; and aromatic ring-containing ether solvents such as diphenyl ether and anisole (methyl phenyl ether).

Examples of the ketone solvents include chain ketone solvents such as acetone, methyl ethyl ketone, methyl-n-propyl ketone, methyl-n-butyl ketone, diethyl ketone, methyl-iso-butyl ketone, 2-heptanone (methyl-n-pentyl ketone), ethyl-n-butyl ketone, methyl-n-hexyl ketone, di-iso-butyl ketone, and trimethylnonanone; cyclic ketone solvents such as cyclopentanone, cyclohexanone, cycloheptanone, cyclooctanone, and methylcyclohexanone; 2,4-pentanedione; acetonylacetone; and acetophenone.

Examples of the amide solvents include cyclic amide solvents such as N,N′-dimethylimidazolidinone and N-methylpyrrolidone; and chain amide solvents such as N-methylformamide, N,N-dimethylformamide, N,N-diethylformamide, acetamide, N-methylacetamide, N,N-dimethylacetamide, and N-methylpropionamide.

Examples of the ester solvents include monocarboxylic acid ester solvents such as n-butyl acetate and ethyl lactate; polyhydric alcohol carboxylate solvents such as propylene glycol acetate; polyhydric alcohol partial ether carboxylate solvents such as propylene glycol monomethyl ether acetate; lactone solvents such as γ-butyrolactone and δ-valerolactone; polyvalent carboxylic acid diester solvents such as diethyl oxalate; and carbonate solvents such as dimethyl carbonate, diethyl carbonate, ethylene carbonate, and propylene carbonate.

Examples of the hydrocarbon solvents include aliphatic hydrocarbon solvents having 5 to 12 carbon atoms such as n-pentane and n-hexane; and aromatic hydrocarbon solvents having 6 to 16 carbon atoms such as toluene and xylene.

Among these, ester solvents are preferable, polyhydric alcohol partial ether carboxylate solvents are more preferable, and propylene glycol monomethyl ether acetate is further preferable. The composition (I) may contain one or two or more of the [B] solvents.

(Other Components)

The composition (I) may contain other components in addition to the [A] polymer and the [B] solvent. Examples of the other components include surfactants. When the composition (I) contains a surfactant, the coatability on the surface of the base material can be improved.

[Method for Preparing Composition (I)]

The composition (I) can be prepared by mixing the [A] polymer, the [B] solvent, and optionally other components at a predetermined ratio, and filtering with a high-density polyethylene filter having pores of about preferably 0.45 μm. The lower limit of the concentration of solid contents of the composition (I) is preferably 0.1% by mass or more, is more preferably 0.5% by mass or more, and is further preferably 0.7% by mass or more. The upper limit of the above-mentioned concentration of solid contents is preferably 30% by mass or less, is more preferably 10% by mass or less, and is further preferably 3% by mass or less.

The composition according to the present embodiment contains the polymer having at least one structure represented by Formula (1-1) above at the terminal of the main chain. In the polymer, the monovalent substituent A₁ having substrate adsorbability is bonded to the terminal of the main chain through the linking group X containing a hetero atom. Therefore, it is presumed that a weak hydrogen bond is generated between the adsorptive terminal groups of the adjacent polymer brushes, thereby attracting to each other. In addition, it is presumed that the presence of the linking group X containing a hetero atom reduces the influence of steric hindrance.

It is presumed that the combination of the above-mentioned effects increases the brush formation density of the composition according to the present embodiment.

(Polymer)

A polymer according to the present embodiment is a polymer having at least one structure represented by Formula (2-1) below at the terminal of the main chain.

[Chem. 9]

*—X-B₁ (2-1)

[In the formula, X represents NR₁, O, S, or Te; R₁ represents a hydrogen atom or a hydrocarbon group having 1 to 20 carbon atoms; B₁ represents a monovalent substituent having, at the terminal, a cyano group, a thiol group, a vinyl group, an ethynyl group, a phosphoric acid group, a phosphoric acid ester group, a phosphonic acid group, a phosphonic acid ester group, a sulfonic acid group, a sulfonic acid ester group, an epoxy group, a pyridyl group, a pyrimidyl group, an imidazole group, a diazonio group, or a halogen; and * represents a bonding site that is bonded to the main chain of the polymer.]

X and R₁ in Formula (2-1) above are the same as X in Formula (1-1) above.

In Formula (2-1) above, a monovalent substituent as B₁ is the same as the monovalent substituent as A₁ in Formula (1-1) above.

B₁ is preferably a group represented by Formula (A-12) above and a group in which A₂ represents a monovalent substituent having, at the terminal, a cyano group, a thiol group, a vinyl group, an ethynyl group, a phosphoric acid group, a phosphoric acid ester group, a phosphonic acid group, a phosphonic acid ester group, a sulfonic acid group, a sulfonic acid ester group, an epoxy group, a pyridyl group, a pyrimidyl group, an imidazole group, a diazonio group, or a halogen.

The polymer according to the present embodiment is useful as a base material component of the composition used for selectively modifying the base material having the surface having two or more regions made of materials that are different from each other.

A method for producing a polymer according to the present embodiment is not particularly limited, and a conventionally known polymerization method can be used. For example, a monomer that induces a repeating unit of a polymer is reacted with a compound containing X in Formula (1-1) above to obtain a polymer intermediate in which X in Formula (1-1) above has been introduced into the main chain, which is then reacted with a compound containing A₁ in Formula (1-1) above, thereby obtaining a polymer in which the structure represented by Formula (1-1) has been introduced into the main chain.

Specifically, for example, in the case of X in Formula (1-1) above, a polymer in which the structure represented by Formula (1-1) has been introduced into the main chain can be obtained by an ene-thiol reaction.

### EXAMPLES

The present invention will be described in more detail below with reference to examples, but the present invention is not limited to these examples.

### Synthesis Example of Polymer

### Synthesis Example 1: Synthesis of Polymer (A0-1)

To a 100 mL Schlenk tube, 0.030 g (0.181 mmol) of azoisobutyronitrile, 7.69 g (76.8 mmol) of methyl methacrylate, 0.20 g (0.90 mmol) of 2-cyano-2-propylbenzodithioate, and 5.0 g of tetrahydrofuran were added, and freeze-pump-thaw degassing was performed five times with liquid nitrogen to set an argon atmosphere. The container was returned to room temperature, and heating and stirring were performed at 70° C. for 10 hours. This polymerization solution was returned to room temperature and diluted by adding 20.0 g of tetrahydrofuran, which was then added dropwise to 250 g of methanol.

The obtained pale orange solid was recovered and dissolved in 30 g of dimethylformamide 3.72 g (37.5 mol) of cyclohexylamine was added thereto under an argon atmosphere, and stirring was performed at room temperature for 5 hours to cause a cleavage reaction of a dithiobenzoate terminal. The reaction solution was added dropwise to 300 g of methanol to obtain a white solid.

The obtained white solid was recovered and dissolved in 30 g of dimethylformamide. 0.06 g (0.4 mmol) of azoisobutyronitrile and 0.62 g (3.8 mmol) of diethyl vinylphosphonate were added thereto under an argon atmosphere to perform heating and stirring at 70° C. for 5 hours. This reaction liquid was returned to room temperature and added dropwise to 300 g of methanol.

The obtained white solid was dried under reduced pressure at room temperature to obtain 5.5 g of a white polymer (A0-1). In this polymer (A0-1), Mw was 9,500, Mn was 8,000, and Mw/Mn was 1.15.

The ¹H-NMR measurement result of the polymer (A0-1) is shown below.

1H-NMR (CDCl₃, 400 MHz) δ (ppm)=4.17-4.05 (m, 4H, —PO(OCH₂CH₃)₂), 3.80-3.41 (br, —COOCH₃), 2.80-2.75 (m, 2H, —SCH₂CH₂P—), 2.19-0.61 (br, alkyl-H, —PO(OCH₂CH₃)₂, —SCH₂CH₂P—)

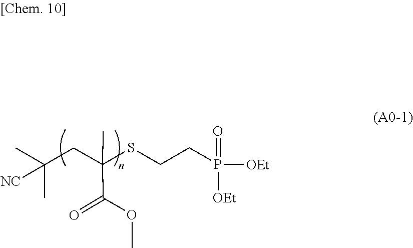

### Synthesis Example 2: Synthesis of Polymer (A0-2)

A polymerization step and a cleavage reaction of a dithiobenzoate terminal were performed in the same manner as in Synthesis Example 1.

The obtained white solid was recovered and dissolved in 30 g of dimethylformamide. 0.06 g (0.4 mmol) of azoisobutyronitrile and 0.41 g (3.8 mmol) of vinylphosphonate were added thereto under an argon atmosphere to perform heating and stirring at 70° C. for 5 hours. This reaction liquid was returned to room temperature and added dropwise to 300 g of methanol.

The obtained white solid was dried under reduced pressure at room temperature to obtain 5.0 g of a white polymer (A0-2). In this polymer (A0-2), Mw was 9,500, Mn was 8,000, and Mw/Mn was 1.15.

The ¹H-NMR measurement result of the polymer (A0-2) is shown below.

1H-NMR (CDCl₃, 400 MHz) δ (ppm)=11.1 (s, 2H, —PO(OH)₂), 3.80-3.41 (br, —COOCH₃), 2.83-2.77 (m, 2H, —SCH₂CH₂P—), 2.19-0.61 (br, alkyl-H, —SCH₂CH₂P—)

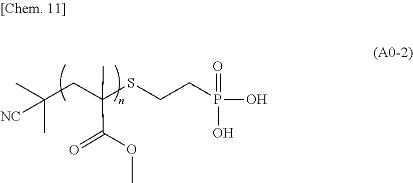

### Synthesis Example 3: Synthesis of Polymer (A0-3)

A polymerization step and a cleavage reaction of a dithiobenzoate terminal were performed in the same manner as in Synthesis Example 1.

The obtained white solid was recovered and dissolved in 30 g of dimethylformamide. 0.06 g (0.4 mmol) of azoisobutyronitrile and 0.39 g (3.8 mmol) of 4-vinylpyridine were added thereto under an argon atmosphere to perform heating and stirring at 70° C. for 5 hours. This reaction liquid was returned to room temperature and added dropwise to 300 g of methanol.

The obtained white solid was dried under reduced pressure at room temperature to obtain 4.7 g of a white polymer (A0-3). In this polymer (A0-3), Mw was 9,200, Mn was 8,100, and Mw/Mn was 1.14.

The ¹H-NMR measurement result of the polymer (A0-3) is shown below.

1H-NMR (CDCl₃, 400 MHz) δ (ppm)=8.48 (d, 2H, Pyridine-H), 7.10 (d, 2H, Pyridine-H), 3.80-3.41 (br, —COOCH₃), 2.90-2.80 (m, 4H, —SCH₂CH₂C—), 2.7-0.61 (br, alkyl-H)

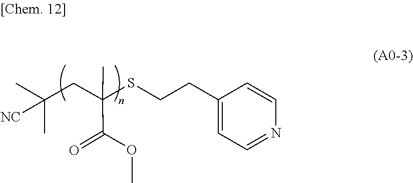

### Synthesis Example 4: Synthesis of Polymer (A0-4)

To a 100 mL Schlenk tube, 0.030 g (0.181 mmol) of azoisobutyronitrile, 6.61 g (76.8 mmol) of methyl acrylate, 0.20 g (0.90 mmol) of 2-cyano-2-propylbenzodithioate, and 5.0 g of tetrahydrofuran were added, and freeze-pump-thaw degassing was performed five times with liquid nitrogen to set an argon atmosphere. The container was returned to room temperature, and heating and stirring were performed at 70° C. for 10 hours. This polymerization solution was returned to room temperature and diluted by adding 20.0 g of tetrahydrofuran, which was then added dropwise to 250 g of methanol.

The subsequent cleavage reaction of a dithiobenzoate terminal was performed in the same manner as in Synthesis Example 1.

The obtained white solid was recovered and dissolved in 30 g of dimethylformamide. 0.06 g (0.4 mmol) of azoisobutyronitrile and 0.35 g (3.8 mmol) of 1-vinylimidazole were added thereto under an argon atmosphere to perform heating and stirring at 70° C. for 5 hours. This reaction liquid was returned to room temperature and added dropwise to 300 g of methanol.

The obtained white solid was dried under reduced pressure at room temperature to obtain 4.8 g of a white polymer (A0-4). In this polymer (A0-4), Mw was 9,200, Mn was 8,000, and Mw/Mn was 1.15.

The ¹H-NMR measurement result of the polymer (A0-4) is shown below.

1H-NMR (CDCl₃, 400 MHz) δ (ppm)=7.46 (s, 1H, Imidazole-H), 6.96 (d, 2H, Imidazole-H), 3.80-3.41 (br, —COOCH₃), 4.00-3.95 (m, 2H, —SCH₂CH₂N), 3.18-3.10 (m, 2H, —SCH₂CH₂N), 2.19-0.61 (br, alkyl-H)

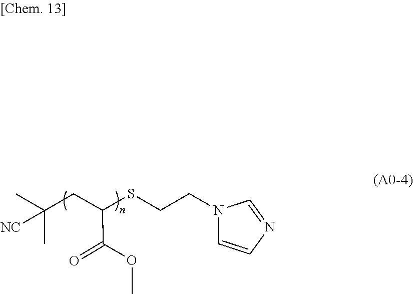

### Synthesis Example 5: Synthesis of Polymer (A0-5)

To a 100 mL Schlenk tube, 0.030 g (0.181 mmol) of azoisobutyronitrile, 13.00 g (77.27 mmol) of 1-methylcyclopentyl methacrylate, 0.20 g (0.90 mmol) of 2-cyano-2-propylbenzodithioate, and 8.5 g of tetrahydrofuran were added, and freeze-pump-thaw degassing was performed five times with liquid nitrogen to set an argon atmosphere. The container was returned to room temperature, and heating and stirring were performed at 70° C. for 10 hours. This polymerization solution was returned to room temperature and diluted by adding 33.8 g of tetrahydrofuran, which was then added dropwise to 423 g of methanol.

The obtained pale orange solid was recovered and dissolved in 55 g of dimethylformamide. 7.08 g (71.4 mol) of cyclohexylamine was added thereto under an argon atmosphere, and stirring was performed at room temperature for 5 hours to cause a cleavage reaction of a dithiobenzoate terminal. The reaction solution was added dropwise to 550 g of methanol to obtain a white solid.

The obtained white solid was recovered and dissolved in 55 g of dimethylformamide. 0.12 g (0.73 mmol) of azoisobutyronitrile and 1.17 g (7.13 mmol) of diethyl vinylphosphonate were added thereto under an argon atmosphere to perform heating and stirring at 70° C. for 5 hours. This reaction liquid was returned to room temperature and added dropwise to 550 g of methanol.

The obtained white solid was dried under reduced pressure at room temperature to obtain 10.3 g of a white polymer (A0-5). In this polymer (A0-5), Mw was 8,700, Mn was 7,500, and Mw/Mn was 1.16.

The ¹H-NMR measurement result of the polymer (A0-5) is shown below.

1H-NMR (CDCl₃, 400 MHz) δ (ppm)=4.17-4.05 (m, 4H, —PO(OCH₂CH₃)₂), 2.90-0.80 (br, —PO(OCH₂CH₃)₂, —SCH₂CH₂P—, alkyl-H)

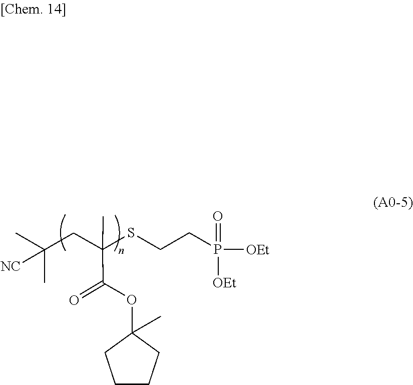

### Synthesis Example 6: Synthesis of Polymer (A0-6)

To a 100 mL Schlenk tube, 0.030 g (0.184 mmol) of azoisobutyronitrile, 7.73 g (78.0 mmol) of N,N-dimethylacrylamide, 0.25 g (0.92 mmol) of 2-phenylpropan-2-yl benzodithioate, and 5.8 g of tetrahydrofuran were added, and freeze-pump-thaw degassing was performed five times with liquid nitrogen to set an argon atmosphere. The container was returned to room temperature, and heating and stirring were performed at 70° C. for 10 hours. This polymerization solution was returned to room temperature and diluted by adding 20.5 g of tetrahydrofuran, which was then added dropwise to 263 g of methanol.

The obtained pale orange solid was recovered and dissolved in 35 g of dimethylformamide 4.23 g (42.6 mol) of cyclohexylamine was added thereto under an argon atmosphere, and stirring was performed at room temperature for 5 hours to cause a cleavage reaction of a dithiobenzoate terminal. The reaction solution was added dropwise to 350 g of methanol to obtain a white solid.

The obtained white solid was recovered and dissolved in 35 g of dimethylformamide 0.07 g (0.4 mmol) of azoisobutyronitrile and 0.70 g (4.3 mmol) of diethyl vinylphosphonate were added thereto under an argon atmosphere to perform heating and stirring at 70° C. for 5 hours. This reaction liquid was returned to room temperature and added dropwise to 350 g of methanol.

The obtained white solid was dried under reduced pressure at room temperature to obtain 6.3 g of a white polymer (A0-6). In this polymer (A0-6), Mw was 9,500, Mn was 8,200, and Mw/Mn was 1.16.

The ¹H-NMR measurement result of the polymer (A0-6) is shown below.

1H-NMR (CDCl₃, 400 MHz) δ (ppm)=7.31-7.18 (m, 5H, Ar—H), 4.17-4.05 (m, 4H, —PO(OCH₂CH₃)₂), 3.18-0.85 (br, —N(CH₃)₂, alkyl-H, —PO(OCH₂CH₃)₂, —SCH₂CH₂P—)

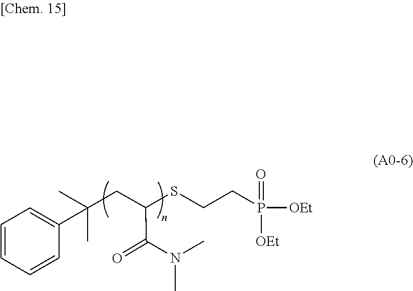

### Synthesis Example 7: Synthesis of Polymer (A0-7)

To a 100 mL Schlenk tube, 0.039 g (0.237 mmol) of azoisobutyronitrile, 10.51 g (100.9 mmol) of styrene, 0.29 g (1.2 mmol) of benzyl benzodithioate, and 7.0 g of tetrahydrofuran were added, and freeze-pump-thaw degassing was performed five times with liquid nitrogen to set an argon atmosphere. The container was returned to room temperature, and heating and stirring were performed at 70° C. for 10 hours. This polymerization solution was returned to room temperature and diluted by adding 24.3 g of tetrahydrofuran, which was then added dropwise to 313 g of methanol.

The obtained pale orange solid was recovered and dissolved in 45 g of dimethylformamide. 5.65 g (57.0 mol) of cyclohexylamine was added thereto under an argon atmosphere, and stirring was performed at room temperature for 5 hours to cause a cleavage reaction of a dithiobenzoate terminal. The reaction solution was added dropwise to 450 g of methanol to obtain a white solid.

The obtained white solid was recovered and dissolved in 45 g of dimethylformamide. 0.09 g (0.5 mmol) of azoisobutyronitrile and 0.62 g (0.57 mmol) of vinylphosphonate were added thereto under an argon atmosphere to perform heating and stirring at 70° C. for 5 hours. This reaction liquid was returned to room temperature and added dropwise to 450 g of methanol.

The obtained white solid was dried under reduced pressure at room temperature to obtain 8.8 g of a white polymer (A0-7). In this polymer (A0-7), Mw was 8,700, Mn was 7,900, and Mw/Mn was 1.10.

The ¹H-NMR measurement result of the polymer (A0-7) is shown below.

1H-NMR (CDCl₃, 400 MHz) δ (ppm)=11.1 (s, 2H, —PO(OH)₂), 7.32-6.26 (br, Ar—H), 2.83-2.77 (m, 2H, —SCH₂CH₂P—), 2.21-1.18 (br, alkyl-H, —SCH₂CH₂P—)

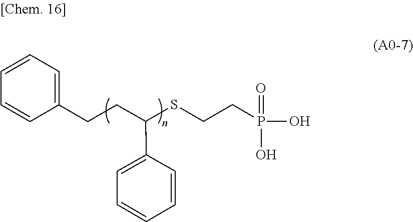

### Synthesis Example 8: Synthesis of Polymer (A0-8)

To a 100 mL Schlenk tube, 0.030 g (0.181 mmol) of azoisobutyronitrile, 5.41 g (54.0 mmol) of methyl methacrylate, 2.87 g (27.6 mmol) of styrene, 0.20 g (0.90 mmol) of 2-cyano-2-propylbenzodithioate, and 5.0 g of tetrahydrofuran were added, and freeze-pump-thaw degassing was performed five times with liquid nitrogen to set an argon atmosphere. The container was returned to room temperature, and heating and stirring were performed at 70° C. for 10 hours. This polymerization solution was returned to room temperature and diluted by adding 20.0 g of tetrahydrofuran, which was then added dropwise to 250 g of methanol.

The obtained pale orange solid was recovered and dissolved in 34 g of dimethylformamide. 4.50 g (45.4 mol) of cyclohexylamine was added thereto under an argon atmosphere, and stirring was performed at room temperature for 5 hours to cause a cleavage reaction of a dithiobenzoate terminal. The reaction solution was added dropwise to 340 g of methanol to obtain a white solid.

The obtained white solid was recovered and dissolved in 34 g of dimethylformamide. 0.07 g (0.4 mmol) of azoisobutyronitrile and 0.75 g (4.6 mmol) of diethyl vinylphosphonate were added thereto under an argon atmosphere to perform heating and stirring at 70° C. for 5 hours. This reaction liquid was returned to room temperature and added dropwise to 340 g of methanol.

The obtained white solid was dried under reduced pressure at room temperature to obtain 6.2 g of a white polymer (A0-8). In this polymer (A0-8), Mw was 9,400, Mn was 7,800, and Mw/Mn was 1.20. As a result of ¹³C-NMR analysis, the molar ratio of the unit derived from styrene to the unit derived from methyl methacrylate in the polymer (A0-8) was 30.0:70.0.

The ¹H-NMR measurement result of the polymer (A0-8) is shown below.

1H-NMR (CDCl₃, 400 MHz) δ (ppm)=7.32-6.26 (br, Ar—H), 4.17-4.05 (m, 4H, —PO(OCH₂CH₃)₂), 3.82-3.38 (br, —COOCH₃), 2.80-2.75 (m, 2H, —SCH₂CH₂P—), 2.26-0.61 (br, alkyl-H, —PO(OCH₂CH₃)₂, —SCH₂CH₂P—)

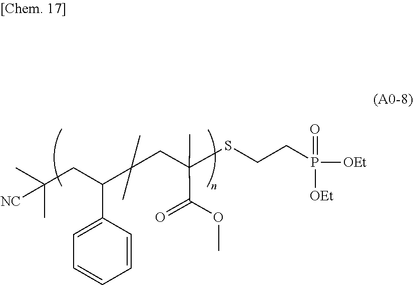

### Comparative Synthesis Example 1: Synthesis of Polymer (A1-1)

A polymer (A1-1) was obtained in the same manner as in Synthesis Example 22 disclosed in Japanese Unexamined Patent Application, First Publication No. 2021-113331.

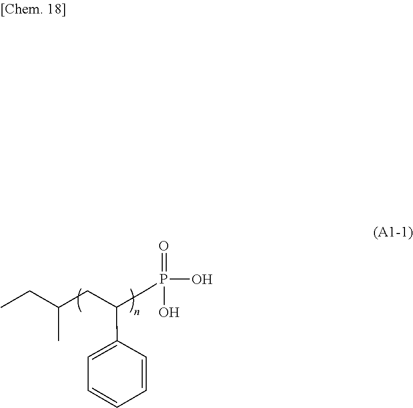

### Comparative Synthesis Example 2: Synthesis of Polymer (A1-2)

A polymer (A1-2) was obtained in the same manner as in Synthesis Example 6 disclosed in Japanese Unexamined Patent Application, First Publication No. 2020-61552.

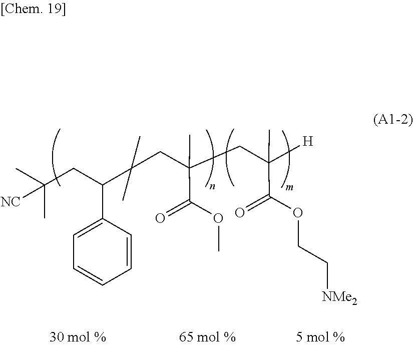

### Examples 1 to 8 and Comparative Examples 1 and 2: Preparation of Composition

The polymers shown in Table 1 were dissolved in propylene glycol monomethyl ether acetate (PGMEA) such that a concentration was 1.0% by mass to obtain a composition of each of the examples.

<Evaluation of Composition>

(Surface Treatment of Substrate)

A tungsten substrate was immersed in 0.2% by mass hydrofluoric acid for 10 seconds, rinsed with pure water, and then dried under a nitrogen flow.

A silicon oxide substrate was subjected to a surface treatment with isopropanol for 10 seconds and dried under a nitrogen flow.

(Formation of Film)

The composition of each of the examples was applied to the surface-treated substrate by spin coating at 1,500 rpm. The substrate to which the composition was applied was baked on a hot plate at 100° C. for 5 minutes in air. Thereafter, the substrate was rinsed with PGMEA to remove an unreacted polymer, and baked at 100° C. for 1 minute to remove the solvent, thereby forming a film on the substrate.

[Evaluation of Contact Angle]

A pure water droplet (2.0 μL) was added dropwise on the surface of the substrate using Drop Master 700 (manufactured by Kyowa Interface Science Co., Ltd.), and measurement was performed once every second, 10 times in total. The measurement was performed at three different points on the substrate, and the average value of a total of 30 times was adopted as the contact angle of water. Table 1 shows the results as “WCA (°)”. As a reference example, the contact angle of a blank substrate before the film formation was measured. Table 1 collectively shows the results.

(Evaluation of Film Thickness)

The film thickness of the formed film was measured using a spectroscopic ellipsometer (product name: M-2000, manufactured by J.A. Woollam Co.). Table 1 shows the results as “Film thickness (nm)”.

(Evaluation of Brush Density)

Calculation was performed from Formula (1) below based on the film thickness.

σ=d×L×NA×10⁻²¹/Mn (1)
σ: Brush density (number of chains/nm²)
d: Density of polymer (g/cm²)
L: Average film thickness (nm)
NA: Avogadro's number
Mn: Number-average molecular weight of polymer (g/number of chains)

For the compositions of Examples 1 to 7 and Comparative Example 1, the calculation was performed with the density of polystyrene (PS) as 1.05 g/cm³ and the density of polymethyl methacrylate (PMMA) as 1.17 g/cm³.

For the compositions of Example 8 and Comparative Example 2, the calculation was performed with PS/PMMA=3/7 and the density as 1.13 g/cm³.

Table 1 shows the results as “Brush density (number of chains/nm²)”.

TABLE 1

| | | | | | | | Brush density |
|---|---|---|---|---|---|---|---|
| | | | Contact angle (°) | | Film thickness (nm) | | (number of |
| | Polymer | Solvent | W | SiO₂ | W | SiO₂ | chains/nm²) |
| Reference | — | — | <10 | 45 | — | — | — |
| Example | | | | | | | |
| Example 1 | A0-1 | PGMEA | 72 | 45 | 7.1 | 0.5 | 0.63 |
| Example 2 | A0-2 | PGMEA | 72 | 46 | 7.0 | 0.6 | 0.62 |
| Example 3 | A0-3 | PGMEA | 70 | 44 | 6.8 | 0.5 | 0.59 |
| Example 4 | A0-4 | PGMEA | 71 | 45 | 6.6 | 0.7 | 0.58 |
| Example 5 | A0-5 | PGMEA | 75 | 46 | 6.7 | 0.5 | 0.63 |
| Example 6 | A0-6 | PGMEA | 73 | 44 | 7.3 | 0.6 | 0.63 |
| Example 7 | A0-7 | PGMEA | 89 | 46 | 7.8 | 0.6 | 0.62 |
| Example 8 | A0-8 | PGMEA | 76 | 45 | 7.2 | 0.5 | 0.63 |
| Comparative | A1-1 | PGMEA | 89 | 44 | 2.8 | 0.4 | 0.38 |
| Example 1 | | | | | | | |
| Comparative | A1-2 | PGMEA | 72 | 45 | 3.0 | 0.5 | 0.30 |
| Example 2 | | | | | | | |

From the results shown in Table 1, it was confirmed that the compositions of Examples 1 to 8 have selectivity with respect to a metal surface. In addition, it was confirmed that the compositions of Examples 1 to 8 had a thicker film thickness of the formed film and a higher brush density than those of the compositions of Comparative Examples 1 and 2.

Although the preferable examples of the present invention have been described above, the present invention is not limited to these examples. The addition, omission, substitution, and other modifications of the configuration are possible within a range not departing from the spirit of the present invention. The present invention is not limited by the foregoing description, but only by the scope of the appended claims.

While preferred embodiments of the invention have been described and illustrated above, it should be understood that these are exemplary of the invention and are not to be considered as limiting. Additions, omissions, substitutions, and other modifications can be made without departing from the scope of the invention. Accordingly, the invention is not to be considered as being limited by the foregoing description and is only limited by the scope of the appended claims.

What is claimed is:

1. A composition for selectively modifying a base material having a surface having two or more regions made of materials that are different from each other, the composition comprising:
a polymer; and
a solvent,
wherein the polymer has at least one structure represented by Formula (1-1) at a terminal of a main chain thereof:
*—X-A₁ (1-1)
wherein X represents NR₁, O, S, or Te; R₁ represents a hydrogen atom or a hydrocarbon group having 1 to 20 carbon atoms; A₁ represents a monovalent substituent having substrate adsorbability at a terminal; and * represents a bonding site that is bonded to the main chain of the polymer.

2. The composition according to claim 1, wherein the polymer has at least one structure represented by Formula (1-2) at the terminal of the main chain thereof:
*—S-A₁ (1-2)
wherein A₁ represents a monovalent substituent having substrate adsorbability at a terminal; and * represents a bonding site that is bonded to the main chain of the polymer.

3. The composition according to claim 1, wherein in Formula (1-1), A₁ is a group represented by Formula (A-11):
*—R_{A}-A₂ (A-11)
wherein R_{A} represents a divalent linking group; A₂ represents a monovalent substituent having substrate adsorbability at a terminal; and * represents a bonding site that is bonded to X in Formula (1-1).

4. The composition according to claim 2, wherein in Formula (1-2), A₁ is a group represented by Formula (A-12):
*—R_{A}-A₂ (A-12)
wherein R_{A} represents a divalent linking group; A₂ represents a monovalent substituent having substrate adsorbability at a terminal; and * represents a bonding site that is bonded to S.

5. A polymer which has at least one structure represented by Formula (2-1) at a terminal of a main chain thereof:
*—X-B₁ (2-1)
wherein X represents NR₁, O, S, or Te; R₁ represents a hydrogen atom or a hydrocarbon group having 1 to 20 carbon atoms; B₁ represents a monovalent substituent having, at a terminal, a cyano group, a thiol group, a vinyl group, an ethynyl group, a phosphoric acid group, a phosphoric acid ester group, a phosphonic acid group, a phosphonic acid ester group, a sulfonic acid group, a sulfonic acid ester group, an epoxy group, a pyridyl group, a pyrimidyl group, an imidazole group, a diazonio group, or a halogen; and * represents a bonding site that is bonded to the main chain of the polymer.
